(19) United States
(12) Patent Application Publication
(10) Pub. No.: US 2005/0144985 A1
(43) Pub. Date: Jul. 7, 2005

(54) Fabrication method for optical fiber preform

(76) Inventors: Sung-Jin Kim, Gumi-si (KR); Sung-Koog Oh, Gumi-si (KR)

Correspondence Address: CHA & REITER, LLC, 210 ROUTE 4 EAST STE 103, PARAMUS, NJ, 07652, US

(21) Appl. No.: 10/836,027

(22) Filed: Apr. 30, 2004

(30) Foreign Application Priority Data
Jan. 2, 2004 (KR) 2004-117

(51) Int. Cl. C03B 37/075

(52) U.S. Cl. 65/397; 65/412

(57) ABSTRACT

A method and apparatus for fabricating an optical fiber preform through an over-jacketing process that reduces an amount of hydroxyl radical formed during the fabrication process. The method includes the steps of preparing a primary preform and a secondary glass tube coaxially aligned with the primary preform, sealing predetermined ends of the primary preform and the secondary glass tube after coaxially aligning the primary preform and the secondary glass tube. Replacement gas is introduced into the primary preform and secondary glass tube, which has a superior property for absorbing hydroxyl radical between the primary preform and the secondary glass tube. The primary preform and the secondary glass tube is completely sealed, lengthwise from the primary preform and the secondary glass tube from the predetermined ends of the primary preform and the secondary glass tube. The hydroxyl radical is replaced with replacement gas by injecting the gas into the space formed between the primary preform and the secondary glass tube before the over-jacketing step is carried out, so that the hydroxyl radical and the replacement gas are exhausted, thereby removing the hydroxyl radical from the optical fiber preform.

### CLAIM OF PRIORITY

This application claims priority to an application entitled “Fabrication method for optical fiber preform” filed in the Korean Intellectual Property Office on Jan. 2, 2004 and assigned Serial No. 2004-00117, the contents of which are hereby incorporated by reference.

### BACKGROUND OF THE INVENTION

1. Field of the Invention

The present invention relates to a method for fabricating an optical fiber preform. More particularly, the present invention relates to a method for fabricating an optical fiber preform by using an over-jacketing device before an optical fiber is fabricated.

2. Description of the Related Art

Conventionally a method for fabricating an optical fiber includes two fabricating steps. A first step is to fabricate an optical fiber preform. A second step is to draw an optical fiber having an outer diameter of 125 um by melting the fabricated optical fiber preform.

A method for fabricating an optical fiber preform is largely divided into two categories: a vapor deposition method and a sol-gel method. The vapor deposition method fabricates the optical fiber preform by the deposition of vaporized raw material. The vapor deposition method can be realized by an inner deposition method, in which raw material is first deposited on an inner surface of a predetermined tube so as to fill the predetermined tube with the raw material, and an outer deposition method, in which raw material is deposited on an outer peripheral surface of an original rod having a small diameter in such a manner that the diameter of the original rod gradually increases.

In contrast, in the sol-gel method, liquefied raw material is injected into a mold, and a phase of the liquefied raw material is then changed into a gel-phase. Subsequently, the gel-phase raw material is sintered so as to form silica glass. The sol-gel method is generally carried out under a low temperature condition, so manufacturing costs are low and the composition of an object can be easily adjusted.

The second step is the optical fiber drawing step that includes drawing a strand of the optical fiber having a predetermined outer diameter from a molten preform by gradually melting the optical fiber preform by heating the optical fiber preform while applying a constant tensile load to the optical fiber preform being molten.

However, the method used for fabricating the optical fiber preform through the above-mentioned process poses a problem when fabricating an optical fiber having a relatively large outer diameter. In other words, the method for fabricating the optical fiber preform by use of the vapor deposition method has a limitation for fabricating an optical fiber preform having an outer diameter of no more than 25 mm. Thus, an over-jacketing method has been used for improving productivity of the fabrication of the larger diameter.

According to the over-jacketing method, a pre-fabricated primary preform is inserted into a secondary glass tube having a large diameter and made of glass material. Then, the secondary glass tube and the primary preform are both heated by a burner, so that the primary preform and the secondary glass tube bond to each other, thereby completing the step of fabricating the optical fiber preform having the large diameter.

An over-jacketing device for fabricating the optical fiber preform of a large diameter type is disclosed in U.S. Publication No. 2003/182,973-A1, which has been filed by applicant of the present invention. According to the above-referenced over-jacketing device, a primary preform and a secondary glass tube are coaxially aligned with each other. Also, after forming a vacuum atmosphere between the primary preform and the secondary glass tube, the primary preform and the secondary glass tube are heated by a burner, so that a secondary optical fiber preform having a large diameter is fabricated.

However, the optical fiber preform fabricated by the above conventional over-jacketing method introduces impurities, such as a hydroxyl radical (OH) that is included in the primary preform. Also, the hydroxyl radical generated by a heating device during the over-jacketing process penetrates from the primary preform into a space formed between the primary preform and the secondary glass tube. The hydroxyl radical remaining between the primary preform and the secondary glass tube remains in the optical fiber even if the optical fiber is withdrawn from the optical fiber preform, thereby causing a loss of an optical signal.

### SUMMARY OF THE INVENTION

Accordingly, the present invention has been made in part to overcome some of the above-mentioned problems. One object of the present invention is to provide a method for removing a hydroxyl radical remaining between a primary preform and a secondary glass tube while an over-jacketing process is being performed.

In order to accomplish the above object, according to the present invention, there is provided a method for fabricating an optical fiber preform through an over-jacketing process, the method includes preparing a primary preform and a secondary glass tube coaxially aligned with the primary preform; sealing predetermined ends of the primary preform and the secondary glass tube after coaxially aligning the primary preform and the secondary glass tube; supplying a replacement gas having a superior property for absorbing hydroxyl radical between the primary preform and the secondary glass tube; and completely sealing the primary preform and the secondary glass tube lengthwise the primary preform and the secondary glass tube from the predetermined ends of the primary preform and the secondary glass tube.

### BRIEF DESCRIPTION OF THE DRAWINGS

The above features and advantages of the present invention will be more apparent from the following detailed description taken in conjunction with the accompanying drawings, in which:

FIG. 1 is a flowchart showing a method for fabricating an optical fiber preform according to a preferred aspect of the present invention; and

FIG. 2 is a view showing a structure of an apparatus for fabricating an optical fiber preform according to the optical fiber preform fabrication method shown in FIG. 1.

### DETAILED DESCRIPTION

Hereinafter, several aspects of the present invention will be described with reference to the accompanying drawings. In the following description and drawings, the same reference numerals are used to designate the same or similar components, and so repetition of the description on the same or similar components will be omitted, particularly when such description might obscure the invention.

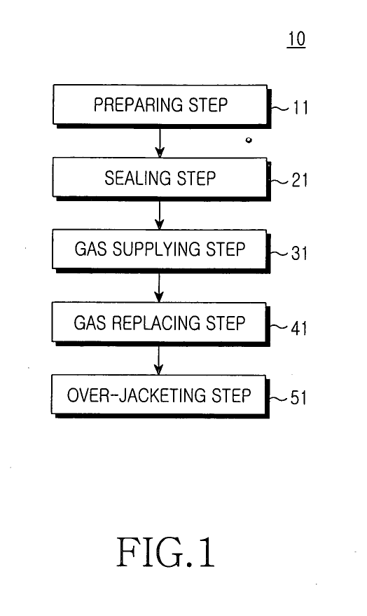

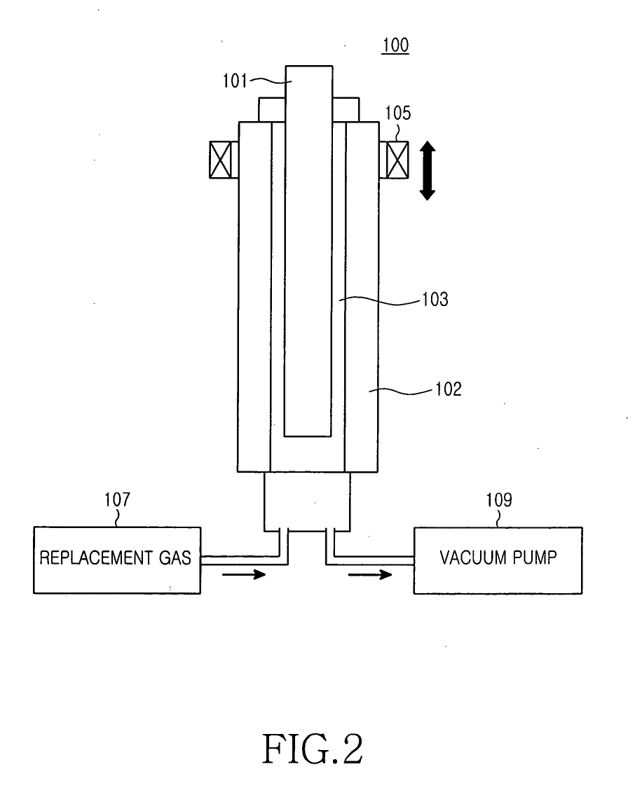

FIG. 1 is a flowchart showing a method 10 for fabricating an optical fiber preform according to an aspect of the present invention. FIG. 2 is a schematic view showing a structure of a device 100 for fabricating the optical fiber preform according to the method 10 used for fabricating the optical fiber preform shown in FIG. 1.

Referring to FIG. 1, the method 10 for fabricating the optical fiber preform according to the present invention includes a preparing step 11, a sealing step 21, a gas supplying step 31, a gas replacing step 41, and an over-jacketing step 51.

Hereinafter, the device 100 for fabricating the optical fiber preform, particularly, an over-jacketing device will be explained in detail with reference to FIG. 2. The over-jacketing device includes a heating device 105, a replacement gas supplying device 107, and a vacuum pump 109. The heating device 105 heats a primary preform 101 and a secondary glass tube 102, which are coaxially aligned with each other, while moving along a longitudinal direction of the primary preform 101 and the secondary glass tube 102. The replacement gas supplying device 107 first provides the replacement gas into a space 103 formed between the primary preform 101 and the secondary glass tube 102, which are coaxially aligned with each other, in replacing step 41. The vacuum pump 109 then removes gas remaining in the space 103 formed between the primary preform 101 and the secondary glass tube 102 in over-jacketing step 51, so that the space 103 is maintained in a vacuum state.

Hereinafter, the method for fabricating the optical fiber preform according to another aspect of the present invention will be explained with reference to FIGS. 1 and 2.

In preparing step 11, the primary preform 101 and the secondary glass tube 102 are prepared to be attached to each other. At this time, the primary preform 101 is formed as a rod shape extending in a longitudinal direction thereof by a vapor deposition method or a sol-gel method. Also, the secondary glass tube 102 extends in a longitudinal direction thereof, and has a tube shape surrounding an outer peripheral surface of the primary preform 101. The secondary glass tube 102 is coaxially aligned with the primary preform 101. The primary preform 101 and the secondary glass tube 102 are fixed to the over-jacketing device 100. Meanwhile, in the over-jacketing step 51, the primary preform 101 and the secondary glass tube 102 are heated at a predetermined temperature by the heating device 105. At this time, in order to uniformly heat the primary p reform 101 and the secondary g lass tube 102, the primary preform 101 and the secondary glass tube 102 are rotated on the over-jacketing device 100 in a circumferential direction.

In sealing step 21, each upper end of the primary preform 101 and the secondary glass tube 102 is sealed. That is, each of upper ends of the primary preform 101 and the secondary glass tube 102 is sealed by softening the upper ends of the primary preform 101 and the secondary glass tube 102 through using the heating device 105. At this time, the heating device 105 generates heat by burning fuel gas, such as oxygen and hydrogen. The primary preform 101 and the secondary glass tube 102 partially include a hydroxyl radical. The hydroxyl radical generated when fuel gas is burned in heating step can penetrate into the space formed between the primary preform 101 and the secondary glass tube 102. Such hydroxyl radical remains in the drawn optical fiber, thereby incurring an optical signal loss. Also, in sealing step 21, moisture generated due to a combustion action of the heating device 105 penetrates into the space formed between the primary preform 101 and the secondary glass tube 102, thereby generating the hydroxyl radical.

For this reason, more hydroxyl radical may be detected at an interfacial surface between the primary preform and the secondary glass tube of the optical fiber preform. In order to remove impurities, such as the hydroxyl radical remaining in the primary preform 101 and the secondary glass tube 102, or remaining in the space formed between the primary preform 101 and the secondary glass tube 102, the present invention injects replacement gas into the space 103 formed between the primary preform 101 and the secondary glass tube 102.

In the gas supplying step 31, a replacement gas is first supplied into the space 103, with the gas having a superior absorption characteristic with respect to the hydroxyl radical that remains in the space formed between or the inside of the primary preform 101 and the secondary glass tube 102. The replacement gas includes CF₄ gas, Cl₂ gas, or D₂ gas. When the replacement gas is provided between the primary preform 101 and the secondary glass tube 102, the replacement gas is replaced with the hydroxyl radical, forming hydrogen gas that is exhausted to an exterior.

In replacing step 41, it is required to wait for a predetermined time in such a manner that the replacement gas is sufficiently replaced with the hydroxyl radical. Also, in replacing step 41, the primary preform 101 and the secondary glass tube 102 can be heated by the heating device 105 in order to activate a replacement reaction between the replacement gas and the hydroxyl radical. At this time, a heating temperature in replacing step 41 is lower than a heating temperature in sealing step 21 or over-jacketing step 51 for softening the primary preform 101 or the secondary glass tube 102.

When the hydroxyl radical remaining between the primary preform 101 and the secondary glass tube 102 is sufficiently subject to the replacement reaction caused by the introduction of the replacement gas, any remaining gas in the space 103 is exhausted to the exterior by operating the vacuum pump 109, so that over-jacketing step 51 is started.

In over-jacketing step 51, the primary preform 101 and the secondary glass tube 102 are completely sealed. Also, over-jacketing step 51 is carried out while maintaining the space 103 formed between the primary preform 101 and the secondary glass tube 102 in the vacuum state by continuously operating the vacuum pump 109. When the space formed between the primary preform 101 and the secondary glass tube 102 is maintained in the vacuum state, the heating device 105 gradually moves from the upper ends of the primary preform 101 and the secondary glass tube 102 to lower ends of the primary preform 101 and the secondary glass tube 102 while heating the primary preform 101 and the secondary glass tube 102. At this time, if the secondary glass tube 102 is softened by the heating device 105, the primary preform 101 and the secondary glass tube 102 are completely sealed due to a pressure difference between an internal portion and an external portion of the secondary glass tube 102. Through the above steps, the primary preform 101 and the secondary glass tube 102 are gradually sealed from the upper ends to the lower ends thereof.

Meanwhile, in the present aspect of the invention, although it is illustrated that the over-jacketing step for the primary preform 101 and the secondary glass tube 102 is gradually carried out from the upper ends of the primary preform 101 and the secondary glass tube 102 to the lower ends thereof, it is possible to carry out the over-jacketing step from the lower ends of the primary preform 101 and the secondary glass tube 102 to the upper ends thereof if the replacement gas supplying device 107 and the vacuum pump 109 are connected to the upper ends of the primary preform 101 and the secondary glass tube 102.

As described above, in the method for fabricating the optical fiber preform according to the present invention, the hydroxyl radical is replaced with replacement gas by injecting the replacement gas, such as CF₄ gas, Cl₂ gas, or D₂ gas into the space formed between the primary preform 101 and the secondary glass tube 102 before the over-jacketing step is carried out, while the upper ends of the primary preform 101 and the secondary glass tube 102 are being sealed. In addition, the hydroxyl radical and replacement gas are exhausted by using the vacuum pump, so that the hydroxyl radical is removed from the optical fiber preform. Accordingly, the optical fiber achieved based on the optical fiber preform fabricated by the method according to the present invention can prevent the optical signal loss derived from the hydroxyl radical.

Although a preferred aspects of the present invention have been described for illustrative purposes, those skilled in the art will appreciate that various modifications, additions and substitutions are possible, without departing from the scope and spirit of the invention as disclosed in the accompanying claims.

1. A method for fabricating an optical fiber preform through an over-jacketing process, the method comprising the steps of:
i) preparing a primary preform and a secondary glass tube coaxially aligned with the primary preform;
ii) sealing predetermined ends of the primary preform and the secondary glass tube after coaxially aligning the primary preform and the secondary glass tube;
iii) supplying a replacement gas having a superior property for absorbing hydroxyl radical from between the primary preform and the secondary glass tube; and
iv) completely sealing the primary preform and the secondary glass tube lengthwise the primary preform and the secondary glass tube from the predetermined ends of the primary preform and the secondary glass tube.

2. The method according to claim 1, wherein the gas is any one selected from the group consisting of CF₄ gas, Cl₂ gas, and D₂ gas, or mixed gas including at least two selected from the group consisting of CF₄ gas, Cl₂ gas, and D₂ gas.

3. The method according to claim 1, wherein step ii) includes forming a vacuum atmosphere between the primary preform and the secondary glass tube.

4. The method according to claim 1, wherein step iii) further comprises a sub-step of replacing a hydroxyl radical contained in both primary the preform and the secondary glass tube with the replacement gas by waiting for a predetermined period of time after introducing the replacement gas in step iii).

5. The method according to claim 4, wherein the primary preform and the secondary glass tube are heated at a predetermined temperature while the replacing step is being carried out.

6. The method according to claim 1, wherein step iv) is carried out under a vacuum state of a space formed between the primary preform and the secondary glass tube.

7. The method according to claim 1, wherein in step iv), outer peripheral surfaces of the primary preform and the secondary g lass tube are heated from the predetermined ends of the primary preform and the secondary glass tube lengthwise the primary preform and the secondary glass tube.
